(19) United States
(12) Patent Application Publication
(10) Pub. No.: US 2018/0113616 A1
(43) Pub. Date: Apr. 26, 2018

(54) DISK ARRAY CONTROL DEVICE, DISK ARRAY DEVICE, DISK ARRAY CONTROL METHOD, AND RECORDING MEDIUM

(71) Applicant: NEC Corporation, Tokyo (JP)

(72) Inventor: Junta TANAKA, Tokyo (JP)

(73) Assignee: NEC Corporation, Tokyo (JP)

(21) Appl. No.: 15/730,915

(22) Filed: Oct. 12, 2017

(30) Foreign Application Priority Data
Oct. 21, 2016 (JP) 2016-206583

(51) Int. Cl. G06F 3/06; G06F 11/10

(52) U.S. Cl. CPC G06F 3/061; G06F 3/0689; G06F 11/1076; G06F 3/064

(57) ABSTRACT

A disk array control device includes a determination unit that receives a reading request in which blocks of connected disk devices are designated, determines whether or not writing has been performed in the designated blocks after initial setting, a) outputs data all of which is a predetermined value when the writing has not been performed, and b) reads and outputs data in the designated blocks when the writing has been performed.

This application is based upon and claims the benefit of priority from Japanese Patent Application No. 2016-206583, filed on Oct. 21, 2016, the disclosure of which is incorporated herein in its entirety by reference.

### TECHNICAL FIELD

The present invention relates to a disk array control device, a disk array control method, and a recording medium, and particularly to a high-speed initial-setting function of a disk array device.

### BACKGROUND ART

When a disk array device structured by a plurality of physical drives is set in RAID 5 or RAID 6, the disk array device needs to read out data from a drive of each member in order to update parity at the time of data update.

FIG. 9 illustrates an example for this situation. FIG. 9 exemplifies a disk array device formed by four disk devices illustrated in a row in the drawing. Here, at the time of updating data D3 and parity P1, the disk array device needs to read out data D1 and D2. This is because parity P1 is created from update data of data D1, D2, and D3. In other words, in order to update two data blocks, the disk array device in FIG. 9 has to read out further two other data blocks.

When increasing the number of disk devices, the number of times of reading out from each member disk increases. For this reason, writing performance of a disk array device of a large-scale configuration is reduced. FIG. 10 illustrates an example for this situation. FIG. 10 exemplifies a disk array device formed by five disk devices. Here, similarly to the case of FIG. 9, at the time of updating data D3 and parity P1, the disk array device needs to read out data D1, D2, and D4. In other words, in order to update two data blocks, the disk array device in FIG. 10 has to further read out three data blocks.

In order to solve this problem, there exists a read-modify-write function (referred to as RMW in the following). The RMW is a function of performing reading and writing for only a writing-target drive and parity, “in a disk array in which matching has been made between data and parity of a member”.

FIG. 11 is a diagram illustrating the RMW function. In this drawing, under a condition that matching has been made between data D1, D2, and D3 and parity P1, only reading, changing, and writing of data D3 and parity P1 is performed when data D3 is updated. Data D1, D2, and D4 are not read out. It is said that random writing performance differs by approximately 30% between a case of using this function and a case of not using this function, and effectiveness of the RMW function has been demonstrated.

PTL 1 (Japanese Patent Application Laid-Open Publication No. 2008-282500) discloses a magnetic disk device that can perform initial setting of a disk at a high speed. This device includes a flag indicating whether a part where user data have been stored is effective or ineffective.

PTL 2 (Japanese Patent Application Laid-Open Publication No. H8-221217) discloses a disk array subsystem that performs data-restructuring on a substitute disk device without interrupting input-output with a host computer, after a malfunctioning disk device is replaced with the substitute disk device. This disk array subsystem includes, in correspondence with blocks of a substitute disk, a flag indicating whether or not data-restructuring has been completed.

### SUMMARY

An object of the present invention is to solve the above-described problem, and complete, at a high speed, initial setting in a disk array device in which a predetermined initial value needs to be set in a disk in such a case as using the RMW function.

An example of aspect of the invention is a disk array control device. The disk array control device comprises a memory storing instructions; and at least one processor that executes the instructions configured to receive a reading request in which blocks of connected disk devices are designated, determine whether or not writing has been performed in the designated blocks after initial setting, a) output data all of which is a predetermined value when the writing has not been performed, and b) read and output data in the designated blocks when the writing has been performed.

Another example of aspect of the invention is a disk array control method. The disk array control method comprises, by at least one processor, receiving a reading request in which blocks of connected disk devices are designated; determining whether or not writing has been performed in the designated blocks after initial setting; outputting data all of which is a predetermined value when the writing has not been performed; and reading and outputting data in the designated blocks when the writing has been performed.

Another example of aspect of the invention is a recording medium recording a program. The program causes a computer to execute a determination process of: receiving a reading request in which blocks of connected disk devices are designated; determining whether or not writing has been performed in the designated blocks after initial setting; outputting data all of which is a predetermined value when the writing has not been performed; and reading and outputting data in the designated blocks when the writing has been performed.

### BRIEF DESCRIPTION OF THE DRAWINGS

Exemplary features and advantages of the present invention will become apparent from the following detailed description when taken with the accompanying drawings in which:

FIG. 1 is a configuration diagram of a disk array system 4 according to a first example embodiment;

FIG. 2 is a diagram illustrating a map stored in a map memory 13;

FIG. 3 is a configuration diagram of a computer device 600;

FIG. 4 is a diagram (First) illustrating operation of a disk array control device 1 in a case of receiving a reading or writing request;

FIG. 5 is a diagram (Second) illustrating operation of the disk array control device 1 in a case of receiving a reading or writing request;

FIG. 6 is a diagram (Third) illustrating operation of the disk array control device 1 in a case of receiving a reading or writing request;

FIG. 7 illustrates a map in which a bit is allocated to every plural sectors;

FIG. 8 is a configuration diagram of a disk array control device 1 according to a third example embodiment;

FIG. 9 exemplifies data update in a disk array device including four disk devices;

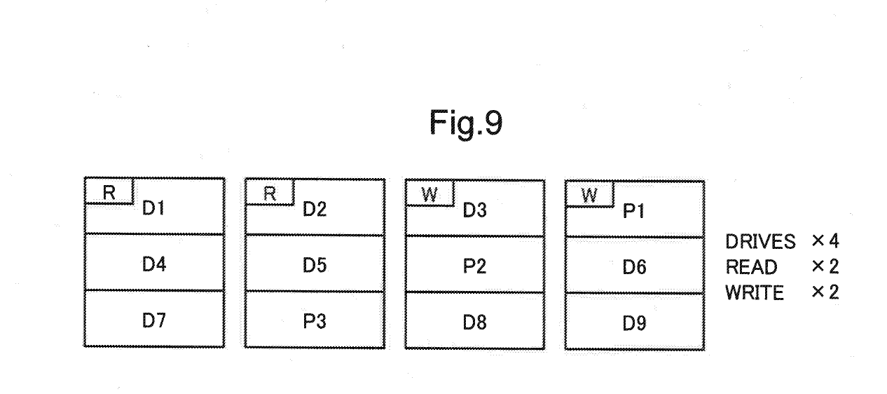

FIG. 10 exemplifies data update in a disk array device including five disk devices; and

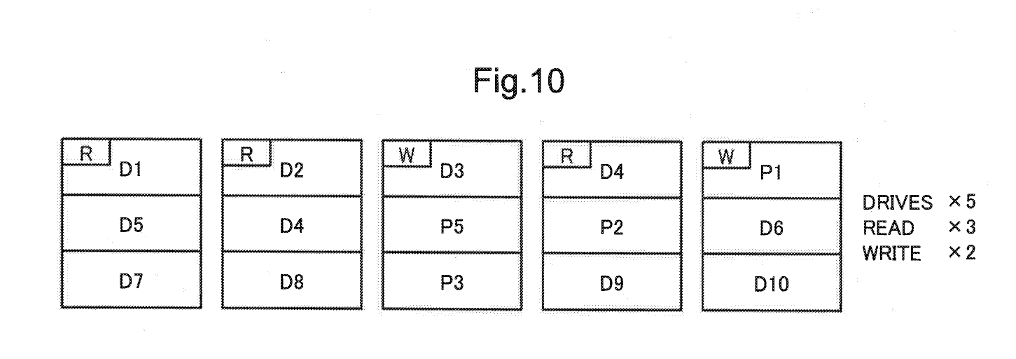

FIG. 11 is a diagram illustrating a read-modify-write function.

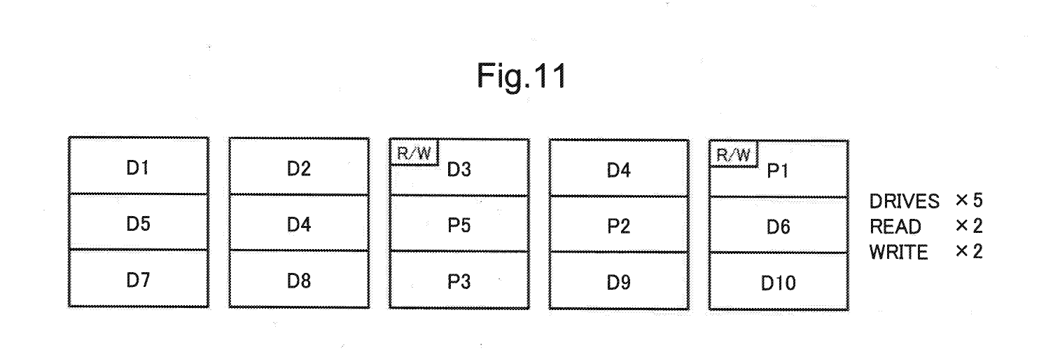

### EXAMPLE EMBODIMENT

A weak point exists in a related RMW function, and as a premise for making the function effective, matching of a disk array device needs to be made. In order that the RMW becomes effective in the disk array device, a check of matching to the disk array device needs to be completed, or “0” writing in an entire surface needs to be performed.

Meanwhile, a capacity of each one of physical disk drive devices tends to increase, and a product whose maximum capacity exceeds 10 terabytes has been produced. In a case of attempting to make matching to a disk array device to make the RMW function effective, a long time is taken before completion depending on the number and capacities of disk devices. Since the matching or the “0” writing in an entire surface is performed at the time of initial setting of the disk array device, increase in an initial setting time has become a problem.

The present invention solves the above-described problem, and completes, at a high speed, initial setting in a disk array device in which a predetermined initial value needs to be set in disks in such a case as using the RMW function.

### First Example Embodiment

### Configuration

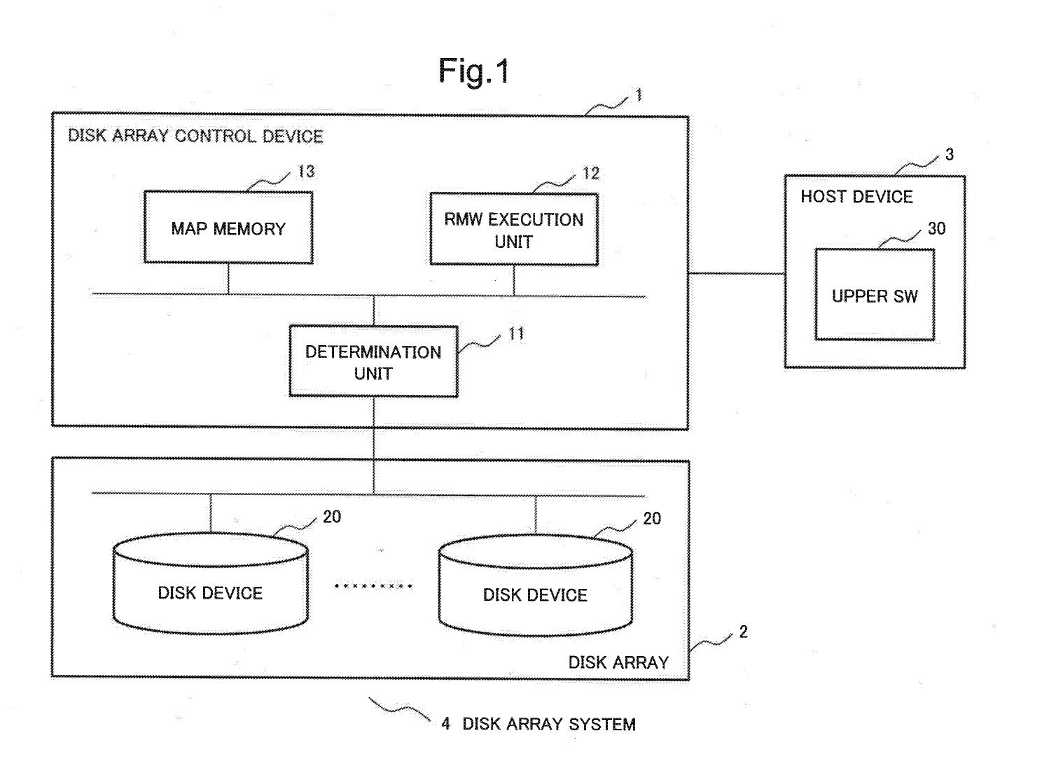

FIG. 1 is a configuration diagram of a disk array system 4 according to a present example embodiment. The disk array system 4 includes a disk array control device 1, a disk array 2, and a host computer 3. The disk array 2 and the host device 3 are connected to the disk array control device 1.

The disk array 2 includes n (n is 3 or more) disk devices 20, and constitutes redundant arrays of inexpensive disks 5 (RAID 5) or RAID 6. The host device 3 is a device accessing the disk array 2 via the disk array control device 1, and is a host computer device, for example. The host device 3 executes a subject accessing the disk array 2, for example, a task processing program. In the following, the subject accessing the disk array 2 is referred to as an upper software (SW) 30. However, the subject accessing the disk array 2 may be a part configured by hardware.

The disk array control device 1 is what is called a disk array controller. The disk array control device 1 according to the present example embodiment includes a determination unit 11, an RMW execution unit 12, and a map memory 13.

The map memory 13 stores a map indicating whether or not each sector (referred to also as a block) of the disk devices 20 in the disk array 2 has been subjected to writing at least once after initial setting of the disk array control device 1.

Referring to the above-described map, the determination unit 11 determines whether or not target sectors of the disk devices 20 have been subjected to writing at least once in response to an input-output request from the upper SW 30 after the initial setting.

The RMW execution unit 12 executes a read-modify-write request issued from the upper SW 30, by using the determination unit 11.

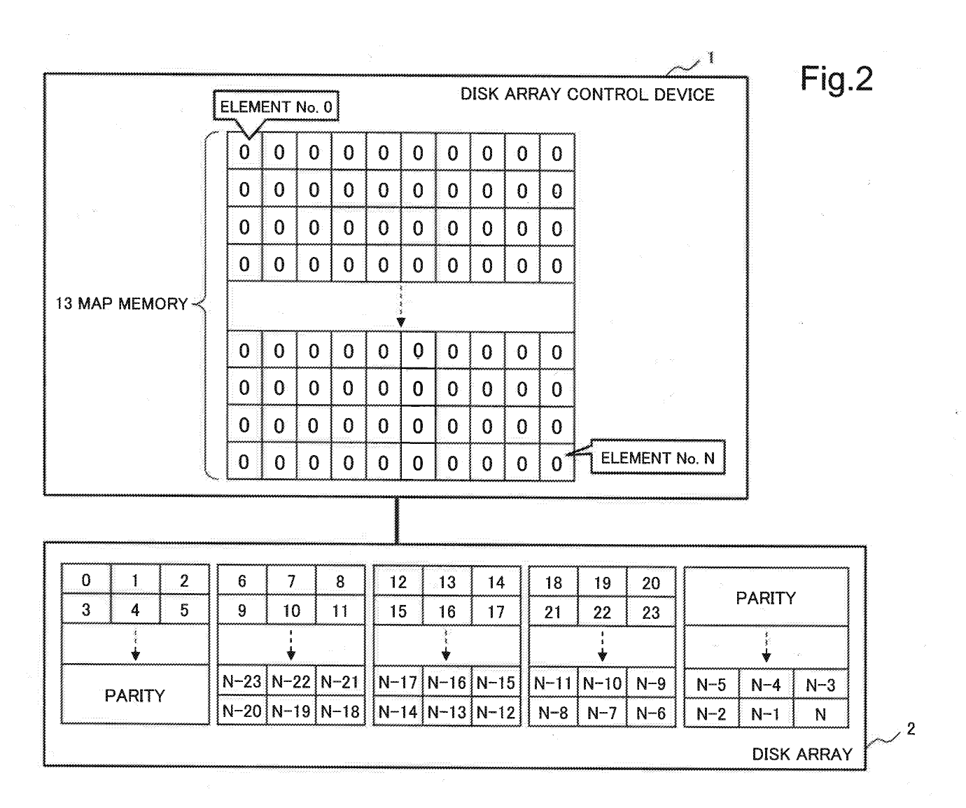

FIG. 2 is a diagram illustrating a map stored in the map memory 13. The map is a bitmap for example, and indicates absence (0) or presence (1) of writing in correspondence with data-storage sectors in each disk device 20.

In the present example embodiment, respective bits stored at respective positions (matrix elements) in a map are respectively in one-to-one correspondence with sectors allocated to the disk devices 20 included in the disk array 2. In FIG. 2, the numbers are allocated to the respective sectors. This number indicates the position of the bit in the map corresponding to the sector. For example, to the respective positions in the map, the numbers may be allocated in advance in accordance with a rule that the order is from the left to the right and from above to below. Under this rule, the number 0 (the first) is allocated to the upper left position in the map, and the number N (the last) is allocated to the lower right position in the map.

The following describes one example of how the sectors corresponding to all the positions in the map are allocated to the disk devices 20 included in the disk array 2.

In a case of the disk array 2 illustrated in FIG. 2, six sectors are allocated, in turn from the disk device 20 at the left end, to each of the disk devices 20 arranged toward the right. For example, in FIG. 2, the sectors from the number 0 to the number 5 are allocated to the disk device 20 at the left end, and the sectors from the number 6 to the number 11 are allocated to the second disk device 20 from the left end.

By the procedure described above, the six sectors corresponding to six bits are allocated to each of the first to fourth disk devices 20. However, sectors for parity are arranged at the fifth disk device 20. This rule applies also to the sixth to tenth disk devices 20 likewise. In other words, six sectors corresponding to six bits are allocated to each of the sixth to ninth disk devices 20, but sectors for parity are arranged at the tenth disk device 20.

After the sectors are allocated up to the disk device 20 at the right end in this manner, sectors are allocated again from the disk device 20 at the left end. In other words, allocation of the second turn is performed. Until the element corresponding to the last position (the lower right matrix element N in FIG. 2) on the map is allocated to one of the disk devices 20, allocation of sectors are performed.

At the time of the initial setting of the disk array control device 1, “0” is set in all the sectors in this map. FIG. 2 illustrates a state at the time of this initial setting.

The determination unit 11 and the RMW execution unit 12 of the disk array control device 1 are configured by logic circuits. The map memory 13 is a memory such as a disk device or a semiconductor memory.

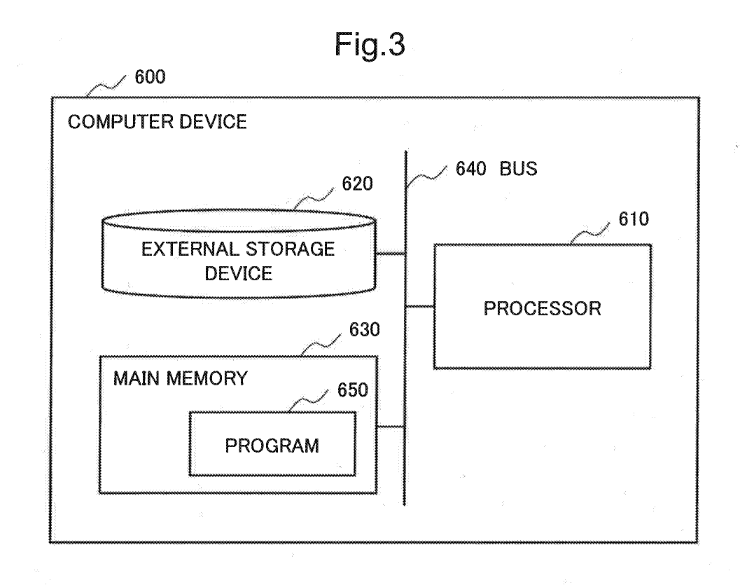

The disk array control device 1 may be implemented by a computer device 600. FIG. 3 is a configuration diagram of the computer device 600. The computer device 600 includes at least one processor 610, a main memory 630, and an external storage device 620 that are connected to each other by a bus 640. The processor 610 reads data from and writes data in the main memory 630 and the external storage device 620, via the bus 640. The processor 610 executes an instruction based on a program 650 stored in the main memory 630. The program 650 may be stored in the external storage device 620 at first, and at the time of the initial setting of the computer device 600, the processor 610 may load the program 650 from the external storage device 620 to the main memory 630.

Here, the main memory 630 is a semiconductor memory. The external storage device 620 is a storage device such as a disk device or a semiconductor memory.

The processor 610 executes the program 650 to thereby function as the determination unit 11 and the RMW execution unit 12. In other words, the processor 610 executes the program 650 to thereby perform the processes performed by the determination unit 11 and the RMW execution unit 12.

The main storage unit 630 or the external storage device 620 is used as the map memory 13.

### Operation

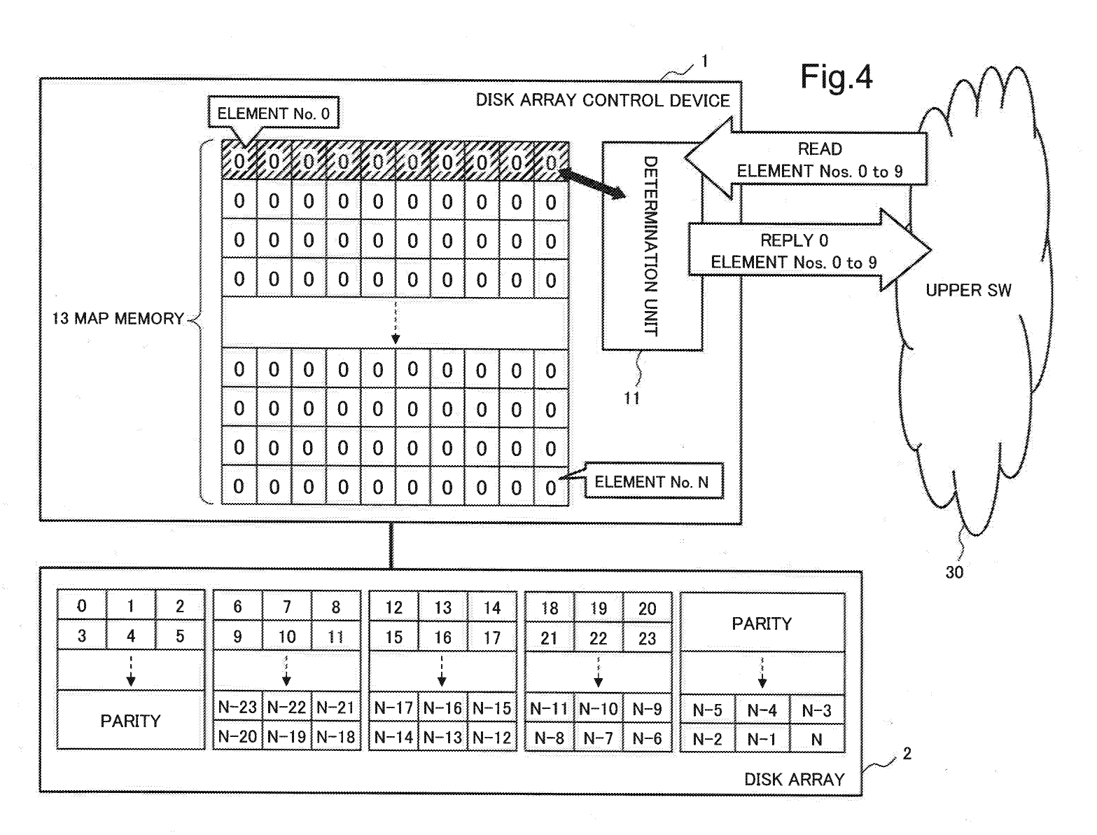

The diagrams of FIG. 4 to FIG. 6 illustrate operation of the disk array control device 1 in a case of receiving a reading or writing request.

FIG. 4 illustrates the operation in the case of receiving a reading request. In FIG. 4, first, the upper SW 30 issues a reading request to the disk array control device 1. The reading request designates reading-target sectors. The reading-target sectors are the sectors 0 to 9, for example.

The determination unit 11 receives the reading request, and determines whether or not the designated sectors have been subjected to writing after the initial setting. The determination unit 11 performs this determination, referring to the bits corresponding to the reading-target sectors, in the map, for example, the bitmap, stored in the map storage unit 13. When the reading-target sectors are the sectors 0 to 9, the determination unit 11 performs this determination, referring to the 0th bit to the 9th bit (the hatched part in the drawing) in the map.

When these bits are “0” (writing absence), the determination unit 11 outputs all-zero data without reading from the disk devices 20. When these bits are “1” (writing presence), the determination unit 11 reads and outputs data of the sectors 0 to 9 in the disk devices 20.

In FIG. 4, the 0th bit to the 9th bit in the map are 0, and in this case, the determination unit 11 outputs the all-zero data without reading from the disk devices 20.

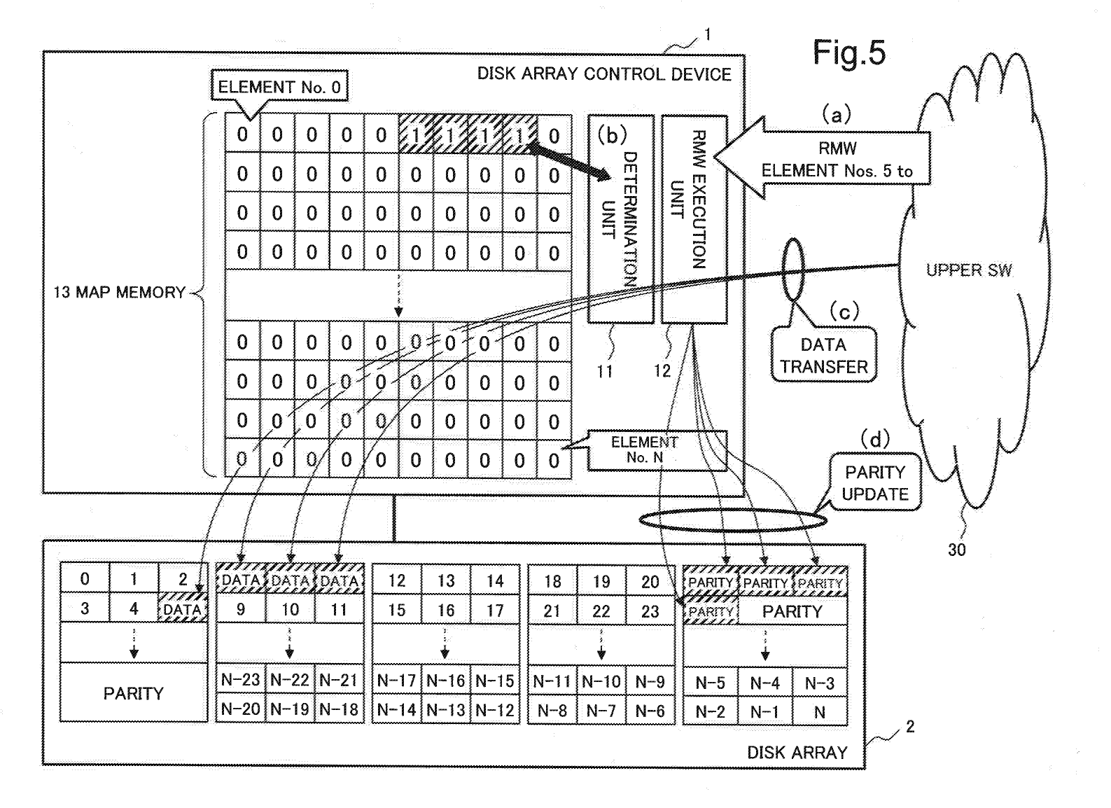

FIG. 5 illustrates the operation in the case of a writing request. First, at (a) in FIG. 5, the upper SW 30 issues a writing request to the disk array control device 1. The writing request designates the writing-target sectors and writing-data. The writing-target sectors are the sectors 5 to 8, for example.

The RMW execution unit 12 receives this writing request, and executes read-modify-write. First, the RMW execution unit 12 designates the writing-target sectors and the sectors where parity data of the writing-target sectors are stored, and requests the determination unit 11 to perform reading.

The determination unit 11 performs reading from the writing-target sectors, by using the map in the map storage unit 13 as described in FIG. 4.

Concerning the sectors storing parity data, the determination unit 11 determines, by the bitmap, whether or not none of the sectors storing data based on which the parity data are calculated have been subjected to writing. When none of the sectors storing data based on which the parity data are calculated have been subjected to writing, the determination unit 11 outputs the all-zero parity data without reading from the disk devices 20. When one of the sectors has been subjected to writing, the determination unit 11 reads the parity data from the disk device 20, and outputs the read parity data.

Next, the RMW execution unit 12 requests the determination unit 11 to perform writing in the writing-target sectors, for example, the sectors 5 to 8. The determination unit 11 writes data in the writing-target sectors in the disk devices 20 ((c) in FIG. 5), and sets “1” (writing presence) in the bits in the bitmap corresponding to the sectors concerned ((b) in FIG. 5).

For example, the determination unit 11 performs writing in the sectors 5 to 8, and sets “1” in the 5th bit to 8th bit (the hatched part in the drawing) in the bitmap.

Then, the RMW execution unit 12 calculates new parity, and updates the parity-storage sectors ((d) in FIG. 5). For example, the RMW execution unit 12 calculates the new parity data from the former data in the writing-target sectors, the written data, and the former parity data.

The disk array control device 1 may include a bitmap also for the sectors storing the parity data. In this case, for the writing-target sectors and for the sectors storing the parity data, the determination unit 11 may perform reading likewise that uses the map in the map storage unit 13 as described above in relation to FIG. 4. Further, for the sectors storing the parity data, the determination unit 11 may perform writing that updates the map in the map storage unit 13 as described above (in relation to (b) and (c) in FIG. 5), as well.

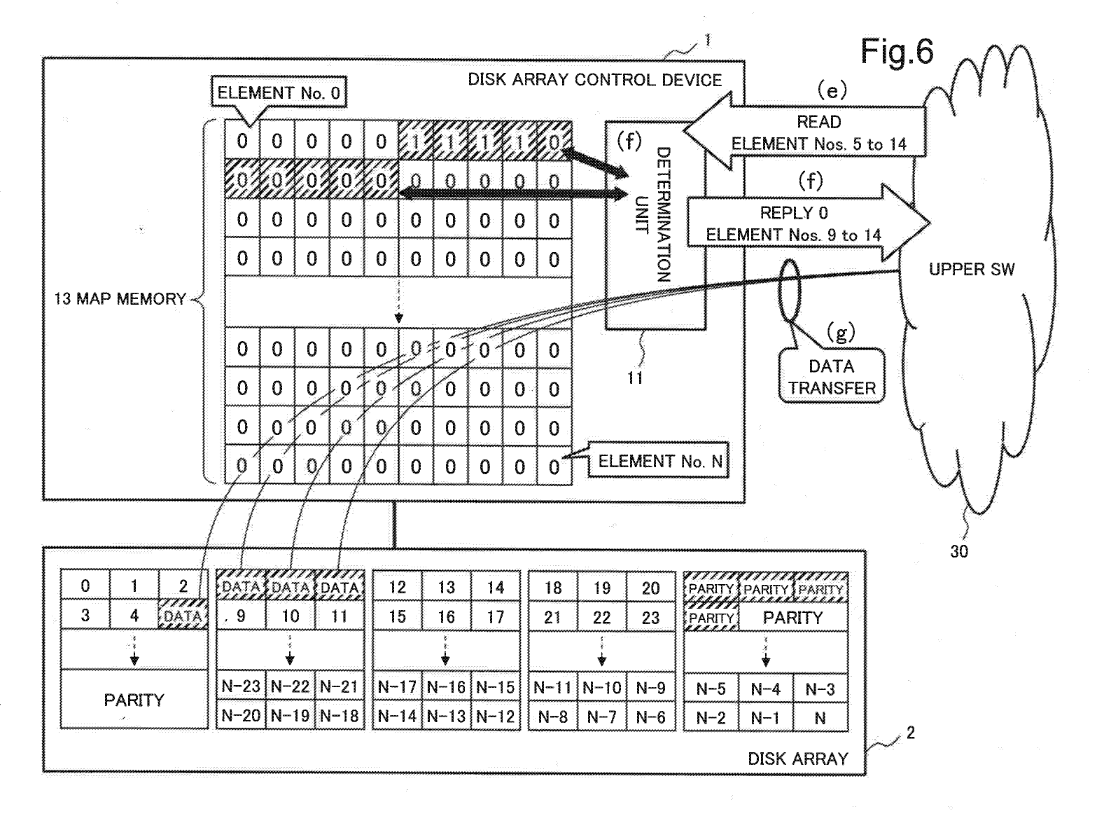

FIG. 6 illustrates the operation when a reading request is made after the writing described above in relation to FIG. 5 is performed after the initial setting.

In FIG. 6, first, the upper SW 30 issues a reading request to the disk array control device 1 ((e) in FIG. 6). The reading-target sectors are sectors 5 to 14, for example.

The determination unit 11 receives the reading request, and determines whether or not the designated sectors 5 to 14 have been subjected to writing after the initial setting, by referring to the 5th bit to the 14th bit (the hatched part in the drawing) in the map.

In the example of FIG. 6, among these bits, the 5th bit to the 8th bit are “1”, and the 9th bit to the 14th bit are “0”. Accordingly, the determination unit 11 reads data from the disk devices 20 for the sectors 5 to 8 to output the read data ((g) in FIG. 6), and outputs zero-data for the sectors 9 to 14 without reading data from the disk devices 20 ((f) in FIG. 6).

### Modified Example

Presence or absence of writing in each sector may be managed by a method other than the map in the map storage unit 13, for example, by a list of identifiers of the sectors that have been subjected to writing.

A reading or writing request may be issued from a different part which is in the disk array control device 1. For example, the upper SW 30 may be executed in the disk array control device 1.

### Advantageous Effect

The disk array control device 1 according to the present example embodiment can complete, at a high speed, initial setting in the disk array 2 using the RMW function. The reason for this is that the determination unit 11 outputs, as a reply, zero-data without reading data from the disk devices 20, in response to a request for reading from the sectors that have not been subjected to writing after the initial setting of the disk array control device 1. Thus, in the initial setting, the disk array control device 1 does not need to write zero-data in the disk devices 20.

In other words, the disk array control device 1 according to the present example embodiment can make the disk array 2 being in a state in which “0” is virtually written in the entire surface, even without performing a process of actually writing “0” in the disk devices 20. This indicates that “a state in which matching of the disk array 2 have been done” can be established as a condition for making the RMW function effective, at the time of structuring the disk array 2, and means that the concern in capacity increase of the disk devices 20 can be solved.

### Second Example Embodiment

### Configuration

In the first example embodiment, the map, for example, the bitmap, stored in the map storage unit 13 includes a bit for each sector in the disk devices 20.

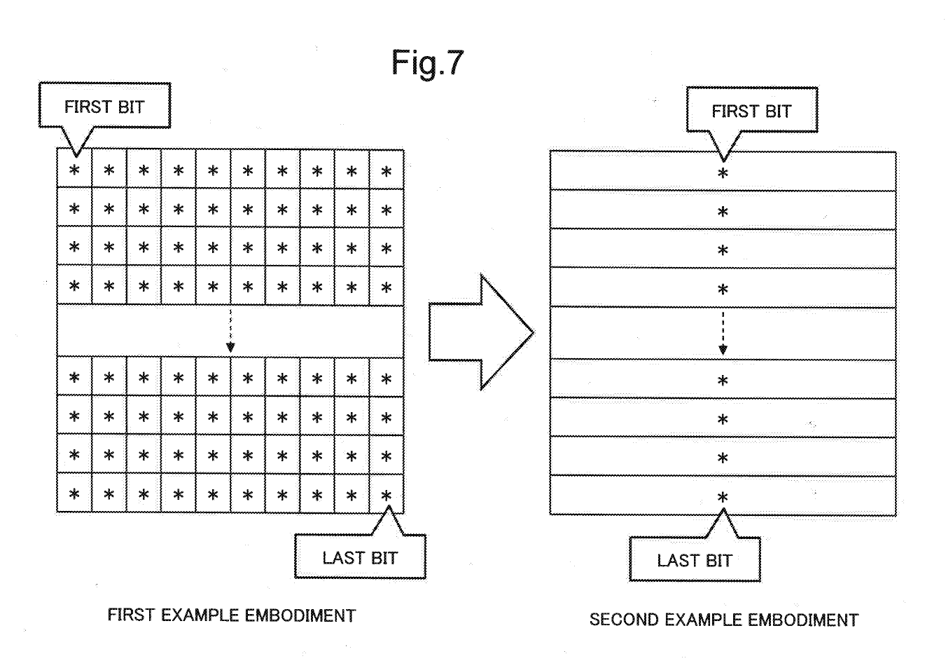

In the present example embodiment, a bit of the map is allocated to every plural sectors. FIG. 7 illustrates the map in which a bit is allocated to every plural sectors.

Out of two maps illustrated in FIG. 7, the right map is the map according to the present example embodiment. The left map relates to the first example embodiment. As described above in the first example embodiment, in the left map, the bits (the matrix elements on the map) are in one-to-one correspondence with the sectors. Meanwhile, in the right map, one bit corresponds to a plurality of (for example, ten) sectors. In other words, in the right map, one bit corresponds to one sector group.

The following is a detailed description of what information of one sector group corresponds to one bit in the present example embodiment.

### Operation

In the present example embodiment, when writing has been performed in one of a plurality of the sectors to which the allocation has been performed, the determination unit 11 sets the bit, for example, in the map to be “1” (writing presence).

The determination unit 11 refers to the map, and determines whether or not one of a plurality of the sector groups including the sectors designated by a reading request have been subjected to writing after initial setting. The determination unit 11 a) outputs data all of which is a predetermined value when none of the sector groups have been subjected to writing, and b) reads data of the designated sectors from the disk devices 20 and outputs the read data when at least one of the sector groups has been subjected to writing.

When a part of a plurality of the sectors corresponding to the bit has been subjected to writing, and there is a reading request for the sectors other than this part, it is supposed that the determination unit 11 reads ineffective data from the disk devices 20. However, since a file system, for example, in the upper SW 30 stores which sectors have been subjected to writing of effective data, reading is not performed on the sectors where ineffective data exists.

### Advantageous Effect

Even when a capacity of the disk devices 20 constituting the disk array 2 increases, it is possible to suppress increase in a capacity of the map stored in the map storage unit 13.

### Third Example Embodiment

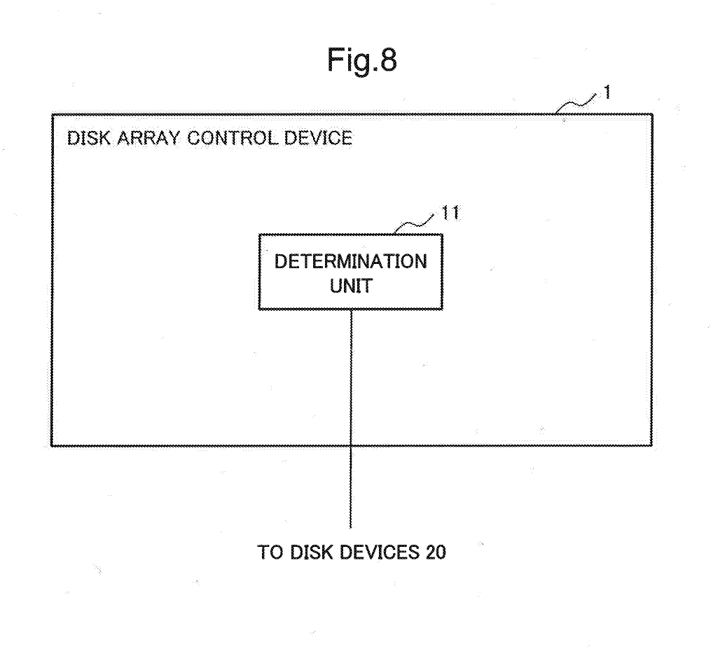

FIG. 8 is a configuration diagram of a disk array control device 1 according to a third example embodiment. The disk array control device 1 includes a determination unit 11.

The determination unit 11 receives a reading request designating sectors in connected disk devices 20, and determines whether or not the designated sectors have been subjected to writing after initial setting. a) When the designated sectors have not been subjected to writing, the determination unit 11 outputs data all of which is a predetermined value, and b) when the designated sectors have been subjected to writing, the determination unit 11 reads and outputs data in the designated sectors.

When the disk array control device 1 includes the read-modify-write function, and the sectors have not been subjected to writing, the predetermined value that is output from the determination unit 11, is zero. When the disk array control device 1 does not include the read-modify-write function, or the sectors have been subjected to writing, the predetermined value may be a different value.

Whether or not respective sectors have been subjected to writing may be managed by a map including state variables each corresponding to a single sector or a plurality of sectors, or may be managed by a list of identifiers of sectors that have been subjected to writing, for example.

A reading request may be issued from a part which is in the disk array control device 1, or may be issued from a different device connected to the disk array control device 1, for example, a host device 3.

The disk array control device 1 according to the present example embodiment can complete, at a high speed, initial setting in which a predetermined initial value needs to be set in disks in such a case as using the RMW function. The reason for this is that the determination unit 11 outputs, as a reply, data of the predetermined value without reading data from the disk devices 20, in response to a reading request for the sectors that have not been subjected to writing after initial setting of the disk array control device 1. Therefore, the disk array control device 1 does not need to write data of the predetermined value in the disk devices 20, in the initial setting.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution. The whole or part of the example embodiments disclosed above can be described as, but not limited to, the following supplementary notes.

### SUPPLEMENTARY NOTE

### Supplementary Note 1

A disk array control device comprising: a memory storing instructions; and at least one processor that executes the instructions configured to receive a reading request in which blocks of connected disk devices are designated, determine whether or not writing has been performed in the designated blocks after initial setting, a) output data all of which is a predetermined value when the writing has not been performed, and b) read and output data in the designated blocks when the writing has been performed.

### Supplementary Note 2

The disk array control device according to Supplementary Note 1, further the at least one processor configured to receive a read-modify-write request in which the blocks of the disk devices constituting RAID 5, and writing-data are designated, read data from the designated blocks and the block storing parity data, change the read data, and write the changed data back in the blocks.

### Supplementary Note 3

The disk array control device according to Supplementary Note 1, wherein the at least one processor configured to determine whether or not, after initial setting, the writing has been performed in a plurality of block groups including the designated blocks, a) output data all of which is a predetermined value when the writing has not been performed, and b) read and outputs data in the designated blocks when the writing has been performed.

### Supplementary Note 4

A disk array control method comprising: by at least one processor, receiving a reading request in which blocks of connected disk devices are designated; determining whether or not writing has been performed in the designated blocks after initial setting; a) outputting data all of which is a predetermined value when the writing has not been performed; and b) reading and outputting data in the designated blocks when the writing has been performed.

### Supplementary Note 5

The disk array control method according to Supplementary Note 4, comprising: receiving a read-modify-write request in which the blocks of the disk devices constituting RAID 5, and writing-data are designated; reading data from the designated blocks and the block storing parity data; changing the read data; and writing the changed data back in the blocks.

### Supplementary Note 6

The disk array control method according to Supplementary Note 4, comprising: determining whether or not, after initial setting, the writing has been performed in a plurality of block groups including the designated blocks; a) outputting data all of which is a predetermined value when the writing has not been performed; and b) reading and outputting data in the designated blocks when the writing has been performed.

### Supplementary Note 7

A recording medium recording a program for causing a computer to execute a determination process of: receiving a reading request in which blocks of connected disk devices are designated; determining whether or not writing has been performed in the designated blocks after initial setting; a) outputting data all of which is a predetermined value when the writing has not been performed; and b) reading and outputting data in the designated blocks when the writing has been performed.

### Supplementary Note 8

The recording medium according to Supplementary Note 7, wherein the program causes a computer to further execute an RMW (read-modify-write function) execution process of: receiving a read-modify-write request in which the blocks of the disk devices constituting RAID 5, and writing-data are designated; reading data from the designated blocks and the block storing parity data; changing the read data; and writing the changed data back in the blocks.

### Supplementary Note 9

The recording medium according to Supplementary Note 7, wherein the program causes a computer to execute the determination process of: determining whether or not, after initial setting, the writing has been performed in a plurality of block groups including the designated blocks; a) outputting data all of which is a predetermined value when the writing has not been performed; and b) reading and outputting data in the designated blocks when the writing has been performed.

What is claimed is:

1. A disk array control device comprising: a memory storing instructions; and at least one processor that executes the instructions configured to receive a reading request in which blocks of connected disk devices are designated, determine whether or not writing has been performed in the designated blocks after initial setting, a) output data all of which is a predetermined value when the writing has not been performed, and b) read and output data in the designated blocks when the writing has been performed.

2. The disk array control device according to claim 1, further the at least one processor configured to receive a read-modify-write request in which the blocks of the disk devices constituting RAID 5, and writing-data are designated, read data from the designated blocks and the block storing parity data, change the read data, and write the changed data back in the blocks.

3. The disk array control device according to claim 1, wherein the at least one processor configured to determine whether or not, after initial setting, the writing has been performed in a plurality of block groups including the designated blocks, a) output data all of which is a predetermined value when the writing has not been performed, and b) read and outputs data in the designated blocks when the writing has been performed.

4. A disk array control method comprising: by at least one processor, receiving a reading request in which blocks of connected disk devices are designated; determining whether or not writing has been performed in the designated blocks after initial setting; a) outputting data all of which is a predetermined value when the writing has not been performed; and b) reading and outputting data in the designated blocks when the writing has been performed.

5. The disk array control method according to claim 4, comprising: receiving a read-modify-write request in which the blocks of the disk devices constituting RAID 5, and writing-data are designated; reading data from the designated blocks and the block storing parity data; changing the read data; and writing the changed data back in the blocks.

6. The disk array control method according to claim 4, comprising: determining whether or not, after initial setting, the writing has been performed in a plurality of block groups including the designated blocks; a) outputting data all of which is a predetermined value when the writing has not been performed; and b) reading and outputting data in the designated blocks when the writing has been performed.

7. A recording medium recording a program for causing a computer to execute a determination process of: receiving a reading request in which blocks of connected disk devices are designated; determining whether or not writing has been performed in the designated blocks after initial setting; a) outputting data all of which is a predetermined value when the writing has not been performed; and b) reading and outputting data in the designated blocks when the writing has been performed.

8. The recording medium according to claim 7, wherein the program causes a computer to further execute an RMW (read-modify-write function) execution process of: receiving a read-modify-write request in which the blocks of the disk devices constituting RAID 5, and writing-data are designated; reading data from the designated blocks and the block storing parity data; changing the read data; and writing the changed data back in the blocks.

9. The recording medium according to claim 7, wherein the program causes a computer to execute the determination process of: determining whether or not, after initial setting, the writing has been performed in a plurality of block groups including the designated blocks; a) outputting data all of which is a predetermined value when the writing has not been performed; and b) reading and outputting data in the designated blocks when the writing has been performed.
